(19) United States
(12) Patent Application Publication
(10) Pub. No.: US 2013/0026022 A1
(43) Pub. Date: Jan. 31, 2013

(54) KEY SWITCH APPARATUS AND ELECTRONIC DEVICE

(71) Applicant: Takao YOKOTA, Kawagoe (JP)

(72) Inventor: Takao YOKOTA, Kawagoe (JP)

(73) Assignee: FUJITSU TOSHIBA MOBILE COMMUNICATIONS LIMITED, Kawasaki-shi (JP)

(21) Appl. No.: 13/554,790

(22) Filed: Jul. 20, 2012

(30) Foreign Application Priority Data
Jul. 28, 2011 (JP) 2011-165540

(51) Int. Cl. H01H 13/76; H01H 13/14

(52) U.S. Cl. 200/5 A; 200/341

(57) ABSTRACT

A key switch apparatus includes a key top, a dome switch and an elastic member. The key top includes a pressing surface whose vertical and lateral lengths are different. The form of the dome switch changes with the key top being pressed. The elastic member is placed around the dome switch and adds a repulsive force against the pressing force by the key top. In addition, in the elastic member, at least a part of the two ends of the longitudinal direction of the pressing surface is missing, in the whole circumference around the dome switch.

### CROSS-REFERENCE TO RELATED APPLICATION

This application is based upon and claims the benefit of priority of the prior Japanese Patent Application No. 2011-165540 filed on Jul. 28, 2011, the entire contents of which are incorporated herein by reference.

### FIELD

The embodiments discussed herein are related to a key switch apparatus and an electronic device including a key top that includes a pressing surface whose vertical and horizontal lengths are different.

### BACKGROUND

Conventionally, a key switch including a key top and a dome switch that is pressed by the key top includes been known.

Among key switch apparatuses, an apparatus in which the center line of the key top and the center line of the dome switch are eccentric has been known.

Patent Document 1: Japanese Laid-open Patent Publication No. 2006-19056

### SUMMARY

A key switch apparatus and an electronic device includes a key top, a dome switch and an elastic member. The key top includes a pressing surface whose vertical and lateral lengths are different. The form of the dome switch changes with the key top being pressed. The elastic member is placed around the dome switch and adds a repulsive force against the pressing force by the key top. In the elastic member, at least a part of the two ends of the longitudinal direction of the pressing surface is missing, in the whole circumference around the dome switch.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plane view illustrating a portable cellular phone according to an embodiment.

FIG. 2 is a plane view illustrating a key switch apparatus according to an embodiment.

FIG. 3 is an oblique perspective view illustrating a key switch apparatus according to an embodiment.

FIG. 4 is a breakdown oblique perspective view illustrating a key switch apparatus according to an embodiment.

FIG. 5 is an A-A sectional view in FIG. 2.

FIG. 6 is an enlarged view (part 1) of the D area in FIG. 5.

FIG. 7 is an enlarged view (part 2) of the D area in FIG. 5.

FIG. 8 is a B-B sectional view in FIG. 2.

FIG. 9 is a C-C sectional view in FIG. 2.

FIG. 10 is a sectional view illustrating the key switch apparatus according to another embodiment.

FIG. 11 is an explanatory diagram illustrating the operation range of a key switch apparatus according to another embodiment.

FIG. 12 is an explanatory diagram illustrating the operation range of a key switch apparatus according to a comparison example (an embodiment).

FIG. 13 is an explanatory diagram for explaining the click rate.

FIG. 14 is a breakdown oblique perspective illustrating a key switch apparatus according to a reference art.

FIG. 15 is a sectional view illustrating a key switch apparatus according to a reference art.

FIG. 16 is an enlarged view (part 1) of the E area in FIG. 15.

FIG. 17 is an enlarged view (part 2) of the E area in FIG. 15.

### DESCRIPTION OF EMBODIMENTS

When the vertical and horizontal lengths of the pressing surface of a key top are different, even the center line of the key top and the center line of the dome switch are eccentric as in the key switch apparatus mentioned above, the pressing feel (the clicking feel) is weak due to slip.

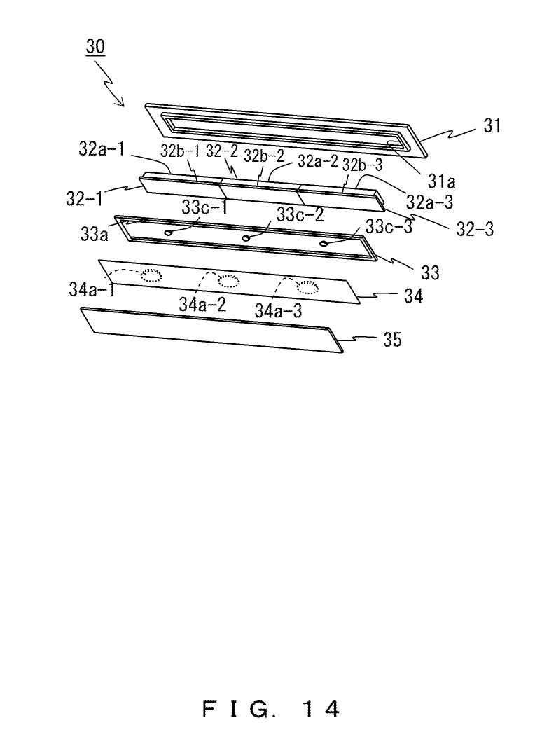

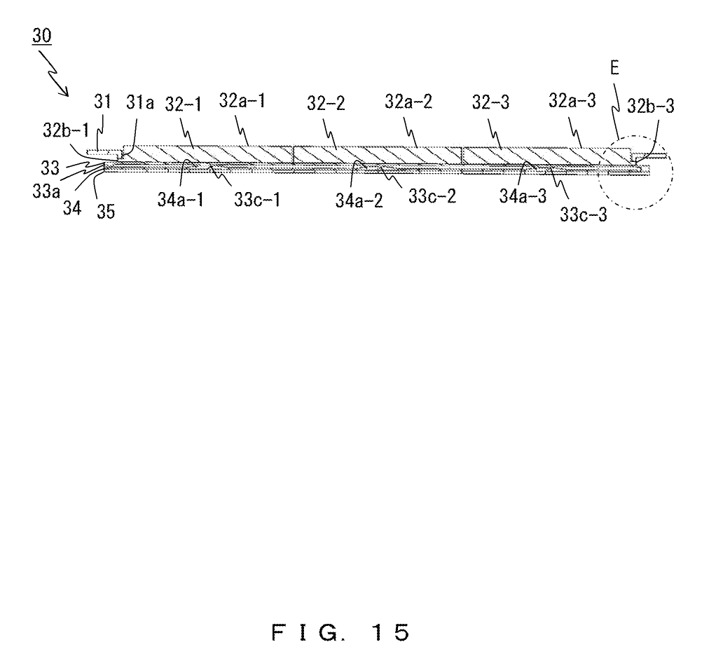

FIG. 14 and FIG. 15 are a breakdown oblique perspective view and a sectional view illustrating the key switch apparatus 30 according to a reference art.

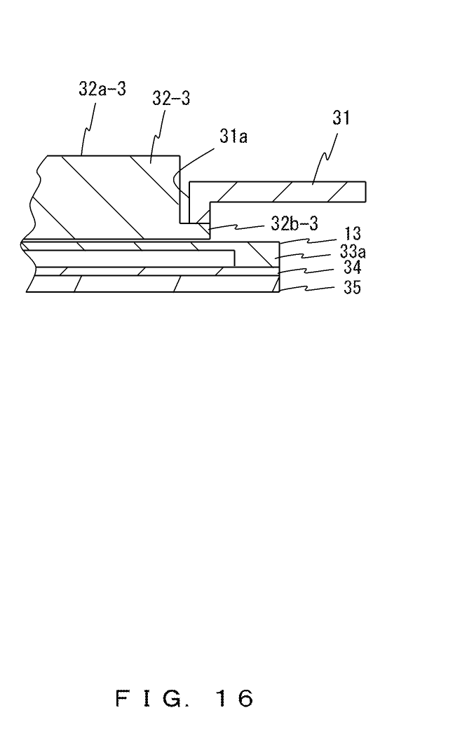

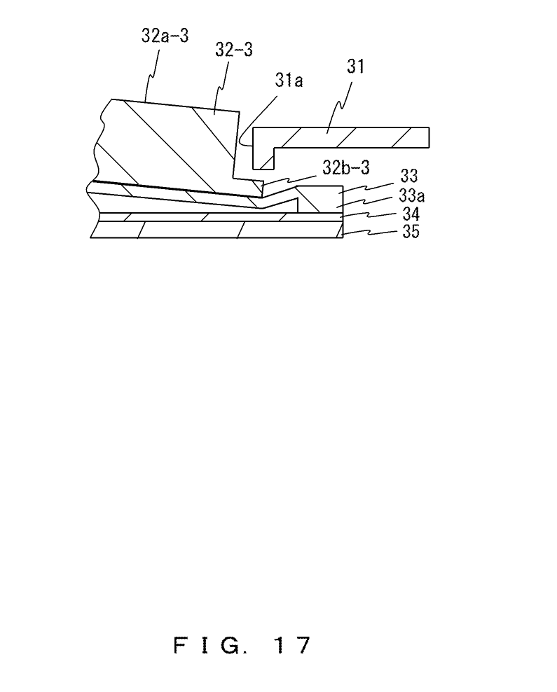

FIG. 16 and FIG. 17 are enlarged views of the E area in FIG. 15.

The key switch apparatus 30 illustrated in FIG. 14 and FIG. 15 includes a key switch apparatus 30, a case 31, key tops 32, a base 33, a key base board 34 and a key plate 35.

The case 31 is in a rectangular frame form on which a flanged through hole 31a is formed in the center.

The key tops 32 are arranged so that the first key top 32-1, the second key top 32-2 and the third key top 32-3 form a line in their longitudinal direction. On the key tops 32, a flange part 32b is formed in the end part on the opposite side of the pressing surface 32a. The flange part 32b is formed in the circumference of the key tops 32 except the part in which the key tops 32 adjoin each other.

The base 33 is composed of a rectangular elastic member, and a rib 33a is provided on the key base board 34 side. The base 33 is formed so as to be longer than the key tops 32 both in its vertical and horizontal directions. On the base 33, three projections 33 that contact three metal domes 34a described later.

The key base board 34 includes three metal domes 34a-1, 34a-2, 34a-3 (hereinafter, each of them is described as “34a”) that are dome switches whose form changes with each of the key tops 32 being pressed.

The key plate 35 supports the key base board 34 on the back side.

In the key switch apparatus 30 described above, when each of the key tops 32 becomes bigger than the size of the metal domes 34a in the width direction for example, the backlash of the rib 33a of the base 33 becomes large when pressing the outer end part of the key tops 32-1, 32-3 on the two ends as illustrated in FIG. 17. Accordingly, the pressing feel (clicking feel) of the key top 32 becomes worse. In addition, the metal domes 34a fail to make contact. If two metal domes are placed for each of the key tops 32, a double-click feel remains.

Hereinafter, a key switch apparatus and an electronic device according to an embodiment is explained with reference to the drawings.

### An Embodiment

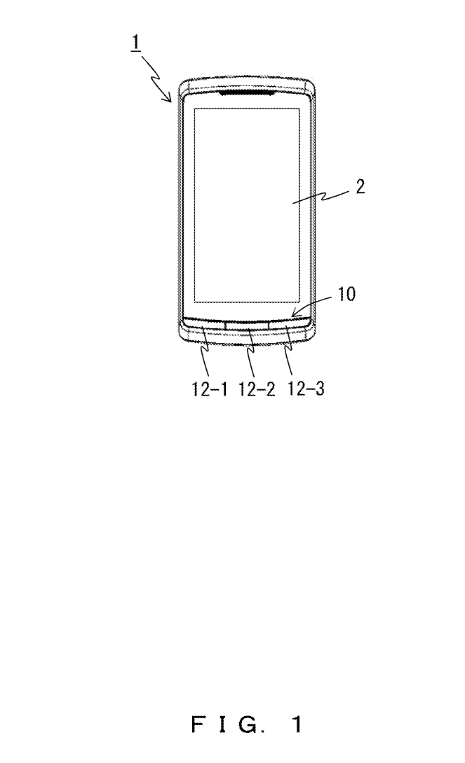

FIG. 1 is a plane view illustrating a portable cellular phone 1 according to an embodiment.

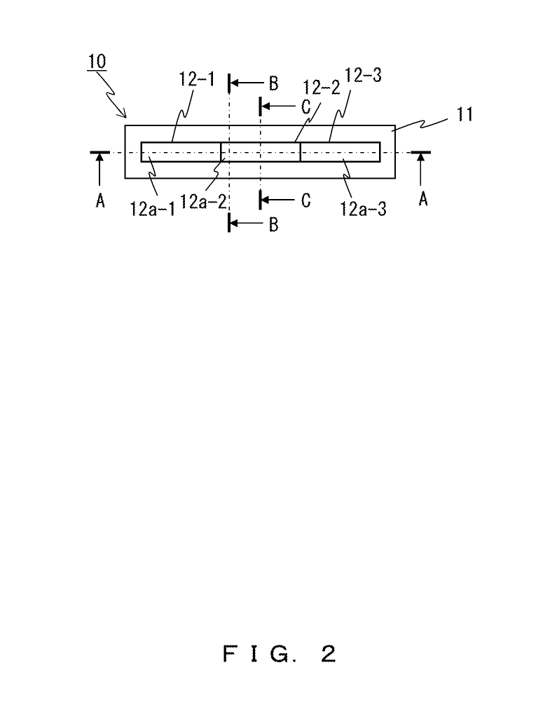

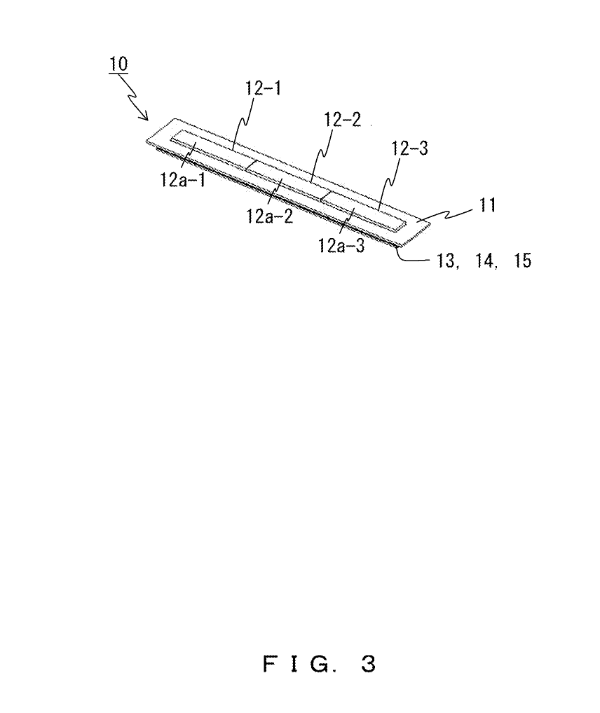

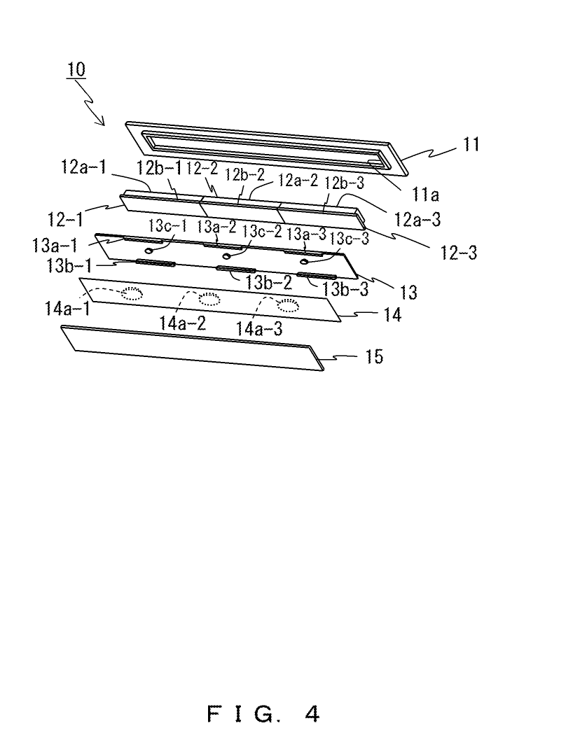

FIG. 2-FIG. 4 are a plane view, an oblique perspective view and a breakdown oblique perspective view illustrating a key switch apparatus according to an embodiment.

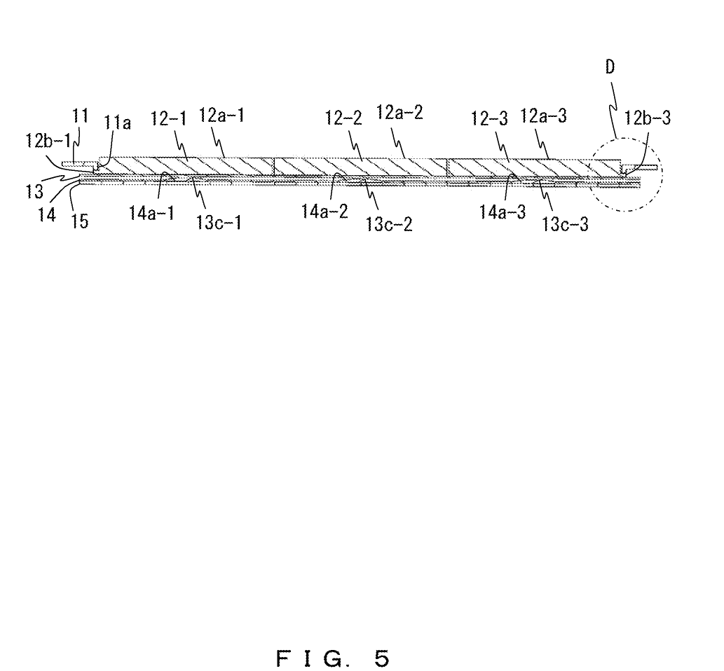

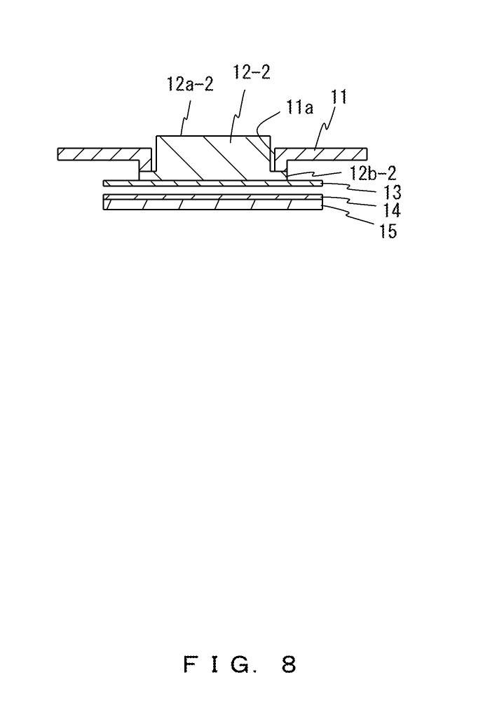

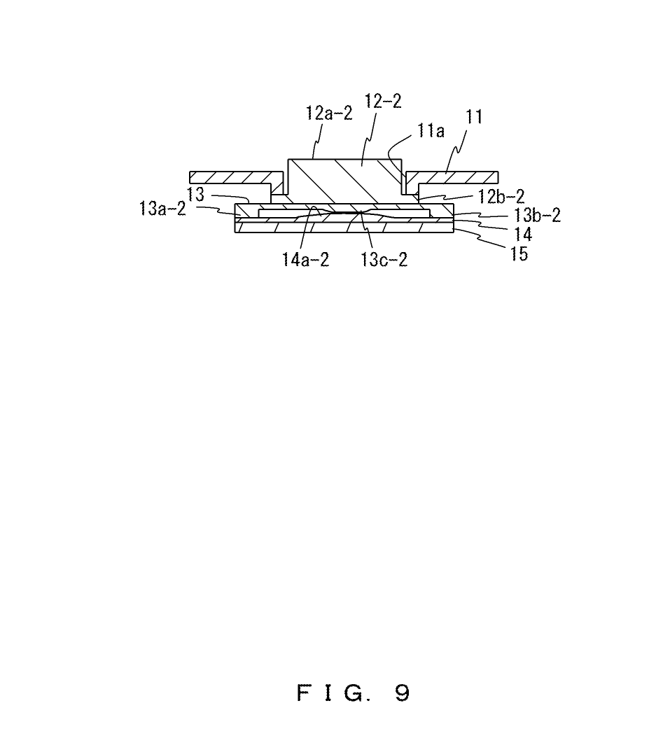

FIG. 5, FIG. 8 and FIG. 9 are an A-A sectional view, a B-B sectional view and C-C sectional view in FIG. 2.

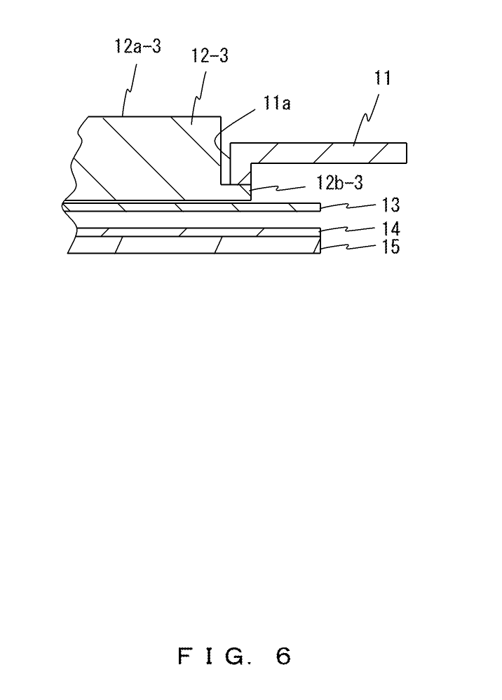

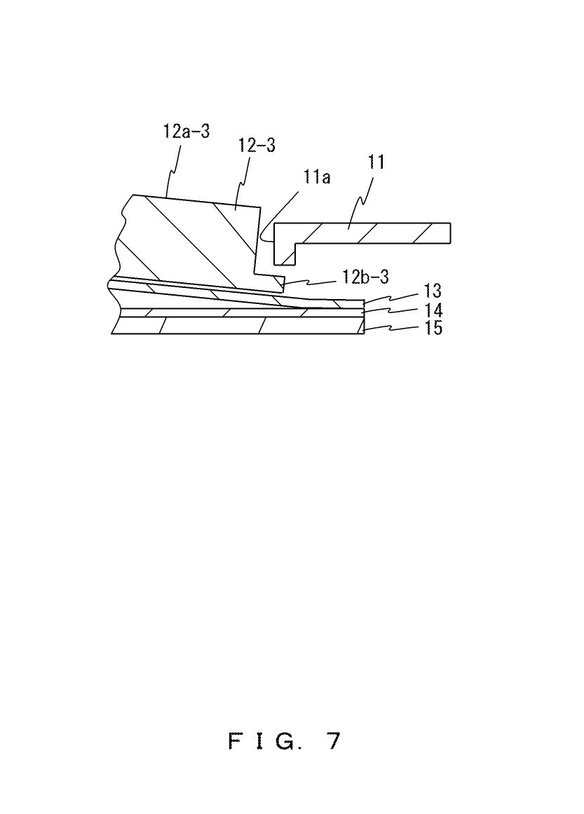

FIG. 6 and FIG. 7 are an enlarged view of the D area in FIG. 5.

The portable cellular phone (portable electronic device) 1 being an example of the electronic device illustrated in FIG. 1 includes a key switch apparatus 10 placed anteriorly to a display unit 2 for example. While the size of the key switch apparatus 10 is different from the size of the key switch apparatus 10 illustrated in FIG. 2 and subsequent drawings, they are similar apparatuses.

The key switch apparatus 10 illustrated in FIG. 2-FIG. 4 includes a case 11, key tops 12-1, 12-2, 12-3 (herein after, each of them is described as “12”), a base 13, a key base board 14 and a key plate 15.

The case 131 is in a rectangular frame form on which a flanged through hole 11a is formed in the center.

The key tops 12 are arranged so that the second key top 12-2 and the third key top 12-3 form a line in their longitudinal direction. On the key tops 12, a rectangular pressing surface 12a whose vertical and horizontal lengths are different is formed.

On the end part that is opposite to the pressing surfaces 12a-1, 12a-2, 12a-3 (hereinafter, each of them is described as “12a”) of the key tops 12, flange parts 12b-1, 12b-2, 12b-3 (hereinafter, each of them is described as “12b”) are formed. The flange part 12b is formed so as to extend on the plane that is parallel to the pressing surface 12a, in the circumference of the key top 12 except the part in which the key tops 12 adjoin each other.

The parts of the key top 12 except the flange part 12b are inserted into a flanged through hole 11a of the case 11 from inside. Accordingly, the pressing surface 12a sticks out on the front side of the case 11.

The base 13 is formed to be bigger than the area composed of the three key tops 12 in both the vertical and horizontal directions. In the circumference of the base 13, ribs 13a-1, 13a-2, 13a-3 (hereinafter, each of them is described as “13a”) that stick out on the key base board 14 side, and ribs 13a-1, 13b-2, 13b-3 (hereinafter, each of them is described as “13b”) are provided with each three being in one for example.

The ribs 13a, 13b are an example of an elastic member, which are located around metal domes 14a-1, 14a-2, 14a-3 (hereinafter, each of them are described as “14a”) corresponding to the respective key tops 12, and adds a repulsive force against the pressing force from the key top 12. The ribs 13a, 13b are provided being integrated with the base 13 made of rubber. The ribs 13a, 13b (base 13) may also be made of an elastic film and the like.

The two ribs 13a, 13b are located across the metal dome 14a as sticks extending in the longitudinal direction of the pressing surface 12a of the key top 12. The ribs 13a, 13b are shorter than the longitudinal length of the pressing surface 12a. Thus, in each of the ribs 13a, 13b, the whole part (an example of at least a part) of the two ends in the longitudinal direction of the pressing surface 12a is missing, in the whole circumference around the metal dome 14a.

The configuration of the ribs 13a, 13b in which at least a part of the two ends in the longitudinal direction of the pressing surface 12a in the whole circumference around the metal dome 14a is missing includes a configuration in which the rib 13a on the two ends of the longitudinal direction of the pressing surface 12a is provided intermittently, a configuration in which the rib 13a on the two ends of the longitudinal direction of the pressing surface 12a is thinner than the center side, and the like.

On the base 13, three projections 13c that contact the metal domes 14a are formed.

The key base board includes the same vertical and horizontal lengths as the base 13. Therefore, the ribs 13a, 13b contact the circumference of the key base board 14. The key base board 14 includes three metal domes 14a whose form changes with each of the key tops 12 being pressed. The metal dome 14a is an example of the dome switch, that switches before and after the change of its form.

The key plate 15 includes the same vertical and horizontal direction as the base 13 and the key base board 14. The key plate 15 supports the key base board 14 on the back side.

In the key switch apparatus 10 described above, the whole part (an example of at least a part) of the ribs 13a, 13b on the two ends of the longitudinal direction of the pressing surface 12a is missing, in the whole circumference around the metal dome 14sa.

Therefore, even if the outer end part of the key switch 12-3 in the longitudinal direction of the pressing surface 12a-3 is pressed as illustrated in FIG. 7, the repulsive force becomes smaller, compared with a rib whose end part is not missing such as the rib 33a in the reference art illustrated in FIG. 17.

In an embodiment described above, in the ribs 13a, 13b that adds a repulsive force against the pressing force by the key top 12, in the whole circumference around the metal dome 14a, at least a part of on the two ends in the longitudinal direction of the pressing surface 12a of the key top 12 is missing. For this reason, according to this embodiment, it becomes possible to improve the pressing feel (clicking feel) of the key top 12, and to make it easy to press the key top 12. Furthermore, by suppressing the repulsive force on the two ends of the longitudinal direction of the pressing surface 12a, it also becomes possible to change the form of the metal dome 14a certainly.

In this embodiment, two ribs 13a, 13b are placed as sticks extending in the longitudinal direction of the pressing surface 12a. Therefore, the repulsive force on the two ends in the longitudinal direction of the pressing surface 12a may be suppressed, while securing the repulsive force by the ribs 13a, 13b.

In this embodiment, the two ribs 13a, 13b that are parallel to the longitudinal direction of the pressing surface 12a is shorter than the length in the longitudinal direction of the pressing surface 12a. Therefore, the repulsive force in on the two ends of the longitudinal direction of the pressing surface 12a may be suppressed certainly.

In this embodiment, a plurality of key tops 12-1, 12-2, 12-3 are located adjacently, and a repulsive force against the pressing force is added to each of the key tops 12 by the ribs 13a, 13b that are different from each other, and the ribs 13a, 13b corresponding to the plurality of key tops 12 are provided on the same base 13. Therefore, the repulsive force by the ribs 13a, 13b may be secured with a simple configuration.

While this embodiment is explained above with an example of the case in which there are three key tops 12, with one, two or more than four key tops, it also becomes easy to press the key top 12 making at least a part of the two ends of the longitudinal direction of the pressing surface 12a missing.

### Another Embodiment

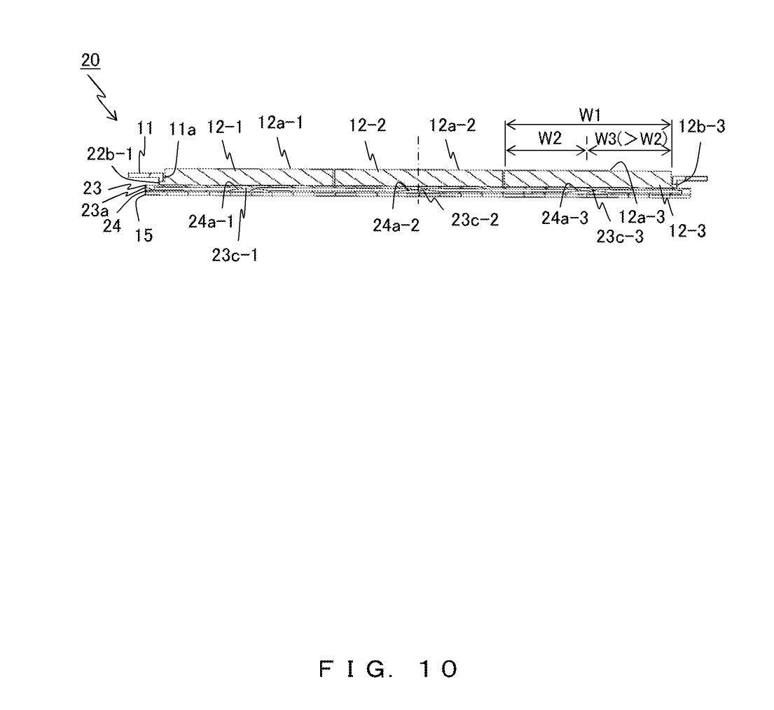

FIG. 10 is a sectional view illustrating a key switch apparatus 20 according to another embodiment.

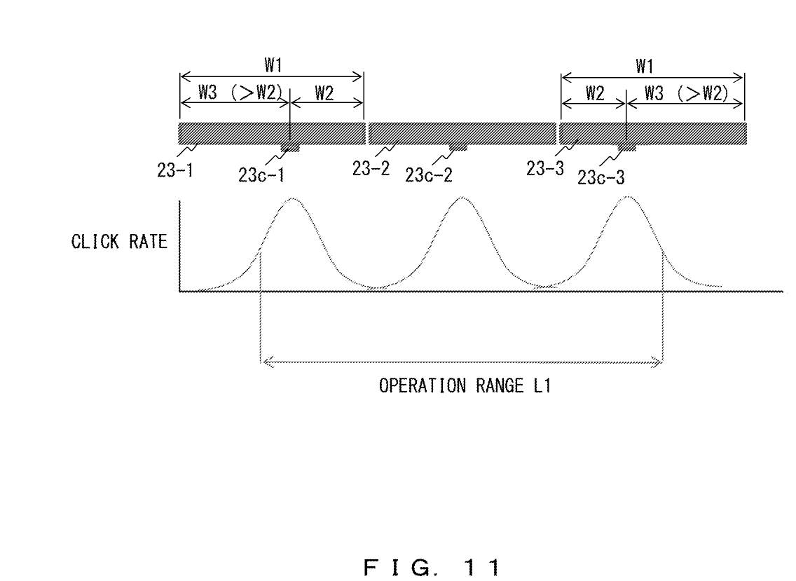

FIG. 11 is an explanatory view illustrating the operation range of the key switch apparatus 20 according to another embodiment.

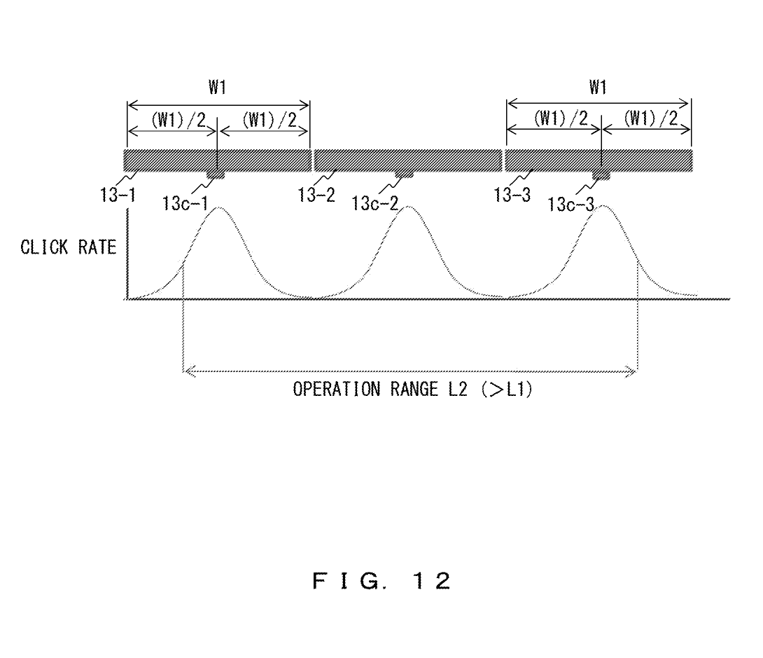

FIG. 12 is an explanatory view illustrating the operation range of the key switch apparatus according to a comparison example (an embodiment).

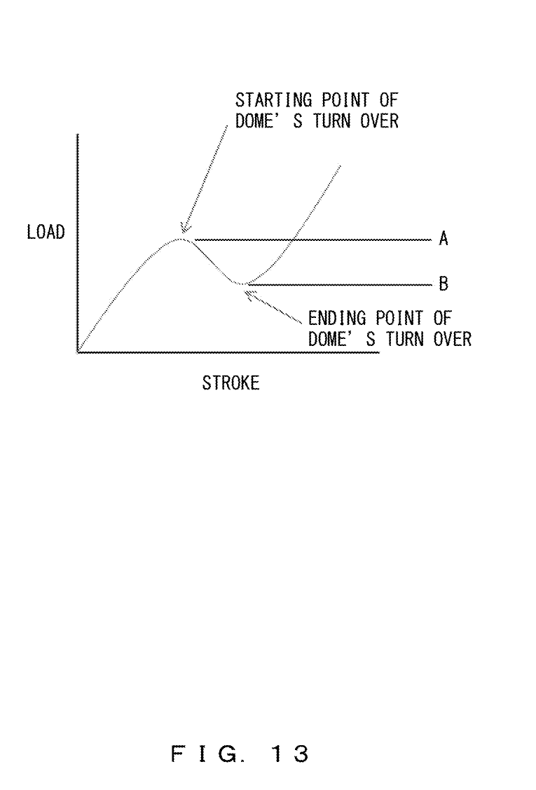

FIG. 13 is an explanatory view for explaining the click rate.

The key switch apparatus 20 of this embodiment differs from the embodiment above only in the base 23 and they key base board 24. Therefore, the same numerals are assigned in the drawings to common configurations, and explanation for them is omitted.

On the base 23, in its whole circumference, a rib 23a (an example of an elastic member) is provided on the key base board 24 side. However, in a similar manner as in the embodiment described above, at least a part of the two ends of the longitudinal direction of the pressing surface 12a may be missing in the whole circumference of the metal domes 14a.

Projections 23c-1, 23c-2, 23c-3 (hereinafter, each of them is described as “23c”) of the base 23 that are pressed by the key tops 12-1, 12-2, 12-3 on the two ends among the plurality of key tops 12-1, 12-2, 12-3, and metal domes 24a-1, 24a-2, 24a-3 (hereinafter, each of them is described as “24a”) of the key base board 24 are placed closer to the center of the area composed of the plurality of key tops 12-1, 12-2, 12-3 than the center of the respective key tops 12-1, 12-3, unlike the embodiment described above.

Therefore, in the key tops 12-1, 12-3 on the two ends, in width W1 in the longitudinal direction of the key top 12, width W2 of the end part that is closer to the center of the area composed of the plurality of key tops 12-1, 12-2, 12-3 is smaller than W3 obtained by subtracting the width W2 from the width W1 in the longitudinal direction of the key top 12.

Accordingly, compared with the case as in the embodiment described above in which the projections 13c-1, 13c-3 (metal domes 14a-1, 14-3) are provided in the center of the key top 12, the operation range by finger become smaller (L<L2)).

The operation ranges L1, L2 refers to a range in which the “click rate” that becomes lower the distance from the projections 23c, 13c (metal domes 24a, 14a) being the center becomes greater is a certain value or above.

The click rate is expressed as “click rate [%]=((A−B)/A)×100”, assuming the load when the metal domes 24a, 14a start turning over as A, and the load when they finish turning over as B.

In this embodiment described above, the metal domes 24a pressed by the key tops 12-1, 12-3 on the two ends among the plurality of key tops 12-1, 12-2, 12-3 are placed closer to the center of the area composed of the plurality of key tops 12-1, 12-2, 12-3 than the center of the key top 12.

For this reason, as illustrated in FIG. 11, the operation range L1 may be small, and therefore, it becomes possible to make it easier to press the key top 12.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A key switch apparatus comprising:
a key top including a pressing surface whose vertical and horizontal lengths are different;
a dome switch whose form changes with the key top being pressed; and
an elastic member places around the dome switch and adds a repulsive force against a pressing force by the key top;
wherein
in the elastic member, at least a part of two ends of a longitudinal direction of the pressing surface is missing, in a whole circumference around the dome switch.

2. The key switch apparatus according to claim 1, wherein
the elastic member is placed in two units as sticks extending in the longitudinal direction of the pressing surface.

3. The key switch apparatus according to claim 2, wherein
the two units of the elastic members are shorter than a length in the longitudinal direction of the pressing surface.

4. The key switch apparatus according to claim 1, wherein
a plurality of the key tops are placed adjacently;
the repulsive force against the pressing force is added to each of the plurality of the key tops by the elastic members different from each other; and
the plurality of the elastic member are provided on a same base.

5. The key switch apparatus according to claim 1, wherein
a plurality of key tops are placed adjacently; and
the dome switches pressed by the key tops of two ends among the plurality of the key tops are placed closer to a center of the area composed of the plurality of key tops than a center of the key top that presses the dome switch.

6. An electronic device comprising:
a key top including a pressing surface whose vertical and horizontal lengths are different;
a dome switch whose form changes with the key top being pressed; and
an elastic member places around the dome switch and adds a repulsive force against a pressing force by the key top;
wherein p1 in the elastic member, at least a part of two ends of a longitudinal direction of the pressing surface is missing, in a whole circumference around the dome switch.

7. The electronic device according to claim 7, wherein
the elastic member is placed in two units as sticks extending in the longitudinal direction of the pressing surface.

8. The electronic device according to claim 7, wherein
the two units of the elastic members are shorter than a length in the longitudinal direction of the pressing surface.

9. The electronic device according to claim 6, wherein
a plurality of the key tops are placed adjacently;
the repulsive force against the pressing force is added to each of the plurality of the key tops by the elastic members different from each other; and
the plurality of the elastic member are provided on a same base.

10. The electronic device according to claim 6, wherein
a plurality of key tops are placed adjacently; and
the dome switches pressed by the key tops of two ends among the plurality of the key tops are placed closer to a center of the area composed of the plurality of key tops than a center of the key top that presses the dome switch.
